(19) United States
(12) Patent Application Publication
(10) Pub. No.: US 2006/0146579 A1
(43) Pub. Date: Jul. 6, 2006

(54) Power filter circuit

(75) Inventor: Wen-Ching Lu, Yilan County (TW)

Correspondence Address: BIRCH STEWART KOLASCH & BIRCH, PO BOX 747, FALLS CHURCH, VA, 22040-0747, US

(73) Assignee: JUNG FONG ELECTRONICS CO., LTD.

(21) Appl. No.: 11/292,083

(22) Filed: Dec. 2, 2005

(30) Foreign Application Priority Data
Jan. 1, 2005 (TW) 094102829

(51) Int. Cl. H02M 3/335; G05F 1/40

(52) U.S. Cl. 363/16; 323/282

(57) ABSTRACT

The present invention discloses an improved power filter circuit, which provides a power supply integrating the passive power filter circuit and the active power filter circuit, wherein via designing the configuration of the circuit, the present invention combines the advantages of the power passive filter circuit and the active power filter circuit and avoids the disadvantages thereof; the active power filter circuit can offset the current phase advance or the current phase lag, which the passive power filter circuit can not solve, and thus, a low-cost power filter circuit having superior output efficiency can be provided.

### FIELD OF THE INVENTION

The present invention relates to an improved power filter circuit, particularly to an improved power filter circuit, which can still maintain a superior output power factor under the influenced of load variation and power supply instability.

### BACKGROUND OF THE INVENTION

With the advance of science and technology, people rely on electrical energy more and more, and electrical power has been a dispensable resource for modem life. Before, people were to be contented as long as there was no scarcity of electrical power. However, owing to the uprise of the living standard and the upgrade of the scientific-technological industry, high-quality power supply has been the common target of all countries. In many countries, the traditional industry has been evolved into the high-technology and high-added-value industry, and it means that various precision equipments have been extensively used; therefore, the requirement of electrical power has also changed, and in addition to purchasing the uprise of power supply quantity, users also pay much attention to the quality of power supply. For power supply quantity, building a multitude of power plants is not the only way to solve the power problem; promoting the power factor or the power efficiency of various electrical products is also an effective method. At present, most electrical equipments utilize direct current directly or indirectly; however, owing to generator systems and the need of power transmission, power plants provide alternating current. Therefore, users have to transform alternating current into direct current with AD/DC converter. Owing to low cost and simple structure, the common AD/DC converter is the diode bridge rectifier, which needs only four diodes. Refer to FIG. 2 for the voltage/current waveforms of the diode bridge rectifier. These kinds of circuit has the disadvantages of the harmonic component of the input current and the phase difference between input voltage and input current; therefore, the power factor is lowered, and there is serious distortion between the waveforms of the output voltage and the input current, which will causes power system instability or even power supply interruption. Owing to the characteristics of the internal impedance, the power factors of many current electrical devices are pretty low; however, users demands power supply quality more and more strictly now; therefore, the improvement of the power factor of power supplies become an important subject, and the technology thereof focuses on the power filter circuits of power supplies.

The main function of a power filter circuit is to make voltage and current in-phase and make a load perform like a resistor, and the abovementioned function can be implemented with various circuit designs, which can be divided into passive power filter circuits and active power filter circuits. Both of them are to be described below:
(A) Passive power filter circuit: refer to FIG. 3 for the voltage/current waveforms thereof; a passive power filter circuit is primarily composed of passive elements, such as resistors, capacitors and inductors, and is used to offset the advance or the lag of power factor; when the requirement of power factor is not so strict, the inductor formed of a plurality of gap-spaced silicon steel sheets is coupled to the input terminal in series, or an inductor cooperates with a capacitor to form an LC-type or π-type low pass filter; according to the resonance modes, the passive power filter circuits can be roughly divided into tuned filters and high pass damped filters; the common tuned filters can be divided into single-tuned filters and double-tuned filters; the common high pass damped filters can be divided into primary, secondary, ternary, and C-type high pass damped filters; the lower the frequency used, the greater the inductance needed; for example, if the ATX power supply of a personal computer is a passive filter circuit, it is often big and heavy, and the best power factor thereof is only as high as 70%; for a strict power factor demand, the passive power filter is not suitable; its best advantage is needing only a simple circuit, and its disadvantages are noise, operational vibration, and low energy conversion efficiency.
(B) Active power filter circuit: refer to FIG. 4 for the voltage/current waveforms thereof; the active power filter circuit utilizes active switch elements and passive elements to make the input current waveform coincide with the voltage waveform and diminish the phase distortion and the waveform distortion of current; thereby, a power factor almost as high as 100% can be achieved; the active power filter also has the function of modulating output voltage level, and its control chip can also provide auxiliary power for the other internal chips of the power supply; according to connection methods, the active power filter circuits can be divided into parallel-type, series-type and series-parallel-type active power filter circuits; as the active power filter has the advantages of small size, low weight and high power factor, it has been extensively used; owing to the complicated structure and high cost, the active power filter circuit is suitable for 90˜270V full range/universal voltage; currently, the active-PFC computer power supply usually adopts a boost-converter design.

In conclusion, the conventional passive and active power filter circuits of power supplies respectively have the problems of noise, lower energy conversion efficiency, and complicated circuit, which makes them unsuitable for use.

### SUMMARY OF THE INVENTION

The primary objective of the present invention is to improve the power factor of power supplies in order to meet the electrical standard and save fabrication cost.

To achieve the abovementioned objective, the present invention proposes an improved power filter circuit of power supplies, which integrates the passive power filter circuit and the active power filter circuit, wherein via designing the configuration of the circuit, the present invention combines the advantages of the passive power filter circuit and the active power filter circuit and avoids the disadvantages thereof; the active power filter circuit can offset the current phase advance or the current phase lag, which the passive power filter circuit can not solve; the improved power filter circuit of the present invention is electrically coupled to a rectifier having AC input terminals and DC output terminals; two filter capacitors are coupled to the DC output terminals of the rectifier; a power source filter circuit, which extends the current switch-on time that the DC current from the DC output terminals charges those two filter capacitors, is installed to the AC input terminals or the DC output terminals of the rectifier; the power source filter circuit further comprises: a first power factor regulating circuit, which creates a harmonic oscillation effect corresponding to the filter capacitors to have a first extended current switch-on time; and a second power factor regulator, which utilizes boosted voltage to force the filter capacitors to store electrical energy and has a second extended current switch-on time to offset the first extended current switch-on time.

### BRIEF DESCRIPTION OF THE DRAWINGS

FIG. 1 is a diagram schematically showing the circuit architecture of the present invention.

FIG. 2 is a diagram showing the waveform of the unmodified system.

FIG. 3 is a diagram showing the waveform of the conventional system modified with an inductor.

FIG. 4 is a diagram showing the waveform of the conventional system offset with voltage-booster.

FIG. 5 is a diagram showing the waveform of the system with improved power factor according to the present invention.

### DETAILED DESCRIPTION OF THE PREFERRED EMBODIMENTS

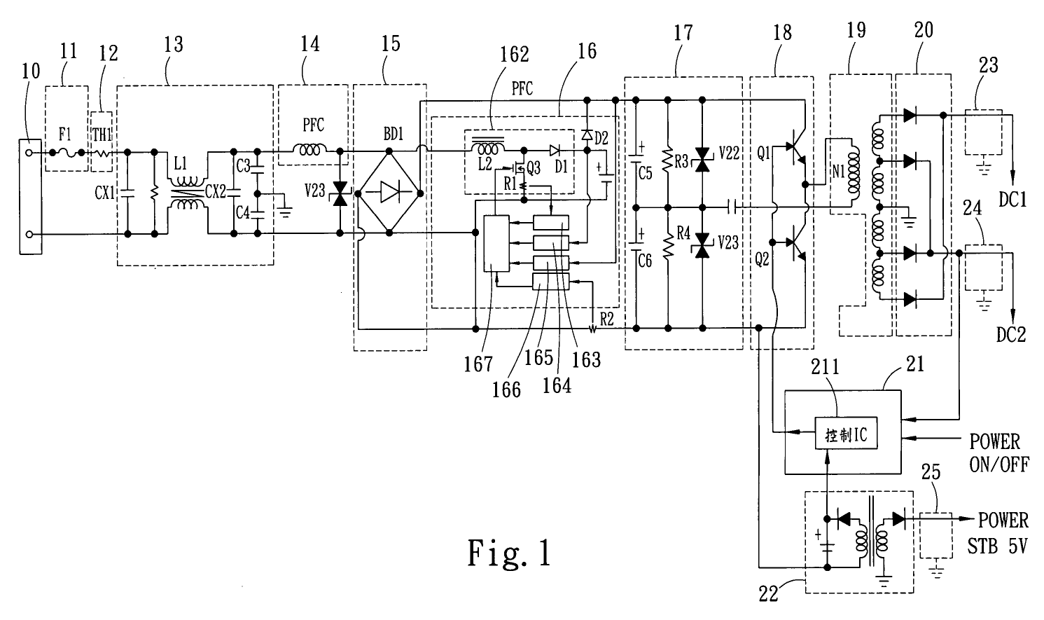

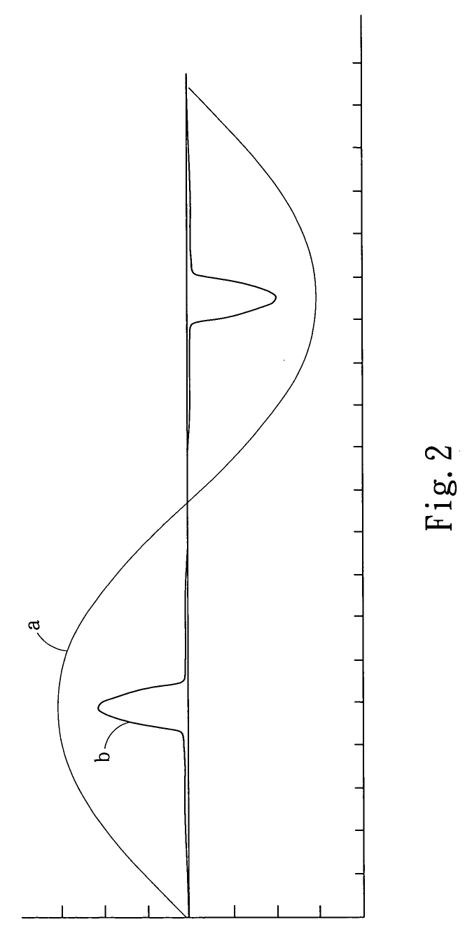

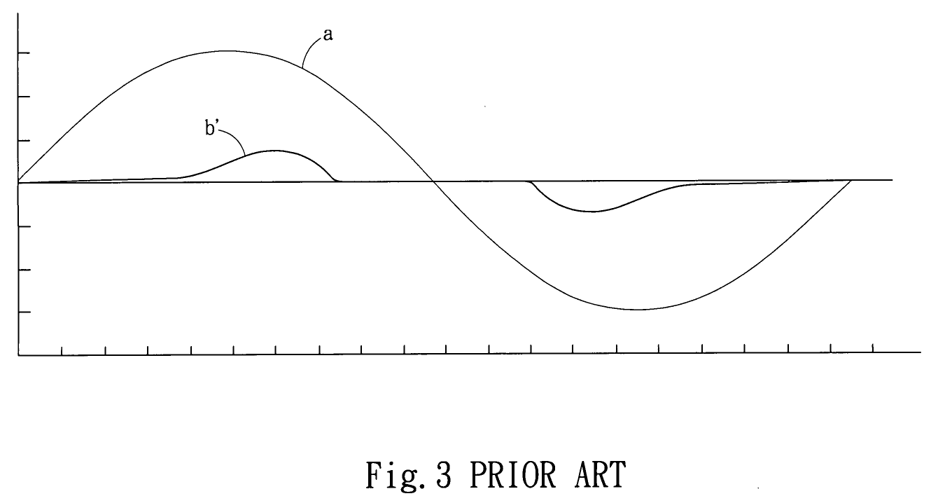

As shown in FIG. 1, the improved power filter circuit of the present invention comprises: an overload protection circuit 11, a surge current limitation circuit 12, a first filter circuit 13, a first power factor regulating circuit 14, a rectifier 15, a second power factor regulating circuit 16, a second filter circuit 17, a power source push circuit 18, a voltage transformer 19, an output rectifier 20, a power source feedback circuit 21, a VCC power source circuit 22, and output filter circuits 23, 24, 25. The first power factor regulating circuit 14, which is an inductor winding, deals with the descending current peak value and the phase lag resulting from the harmonic oscillation created by the filter capacitors C5, C6 of the second filter circuit 17. Refer to FIG. 2 and FIG. 3. FIG. 2 is a diagram showing the voltage/current waveform of the system without the first power factor regulating circuit 14. As shown in FIG. 2, in a complete cycle of voltage a, the peak value of current b is relatively higher, and the cycle of current b is smaller. FIG. 3 shows the voltage/current waveform of the system after the first power factor regulating circuit 14 has been added thereto. As shown in FIG. 3, the current switch-on time of current b′ has been obviously extended, and the peak value of current b′ has been lowered, and thus, there is a first extended current switch-on time.

The second power factor regulating circuit 16 further comprises:

A front voltage-booster loop 162, further comprising: a voltage-booster inductor winding L2, a power transistor Q3, and a diode D1, and used to raise the voltage output by the rectifier 15 to the rated value at which electrical energy can be stored in those two filter capacitors C5, C6 in order to offset the current phase advance or the current phase lag, which the first power factor regulating circuit 14 cannot solve, so that there is always current created during the whole voltage cycle, and the front voltage-booster loop 162 advances the first extended current switch-on time and postpones the second extended current switch-on time;

A current-limiting protection loop 163, used to limit the output power (watt) of the second power factor regulating circuit 16;

An overvoltage protection loop 164, used to limit the output voltage of the second power factor regulating circuit 16;

An error-amplifying loop 165, used to detect the terminal voltages of the filter capacitors C5, C6;

A line current-detecting loop 166, used to detect the current, which charges the filter capacitors C5, C6; and

A PWM controller 167, used to regulate the output of the front voltage-booster loop 162.

The operation process of the second power factor regulating circuit 16 is described as follows: when AC power is input from power terminals 10 and passes through the overload protection circuit 11, surge current limitation circuit 12, first filter circuit 13, and first power factor regulating circuit 14, it is rectified by the rectifier 15 (otherwise, a rectifier may also be installed between the power source terminals 10 and the front voltage-booster loop 162); the power transistor Q3 of the front voltage-booster loop 162 raises the voltage output by the rectifier 15 from voltage-booster inductor winding L2 to the rated value; the PWM controller 167 receives the detected parameters from the current-limiting protection loop 163, overvoltage protection loop 164, error-amplifying loop 165, and line current-detecting loop 166 and then performs comparisons and calculations to work out the working bandwidth to control the power transistor Q3 so that the power output by the second power factor regulating circuit 16 can be maintained within the rated value.

The process of creating and acquiring the parameters is described as follows:
1. When the power (watt) output by the second power factor regulating circuit 16 exceeds the originally rated value (below 40 watt in one preferred embodiment of the present invention), the current-limiting protection loop 163 will acquire the parameter of this status from the resistor R1 of the front voltage-booster loop 162;
2. When the voltage output by the second power factor regulating circuit 16 is too high, the overvoltage protection loop 164, which is connected to the cathode of the diode D1, can detect this voltage value;
3. The error-amplifying loop 165 is used to detect the terminal voltages of the filter capacitors C5, C6; and
4. When the line terminal voltage reaches the terminal voltage of the filter capacitors C5, C6, massive charging current will be created, and the line current-detecting loop 166 will detect this line current from the resistor R2.

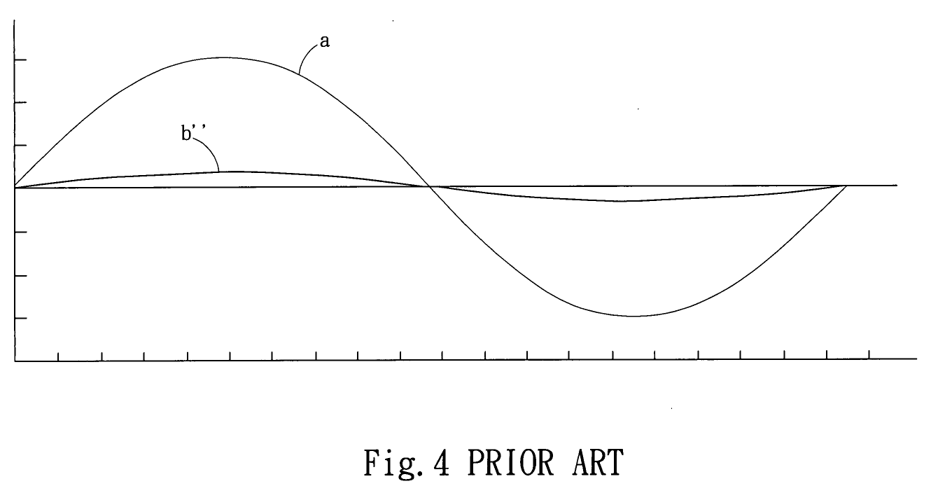

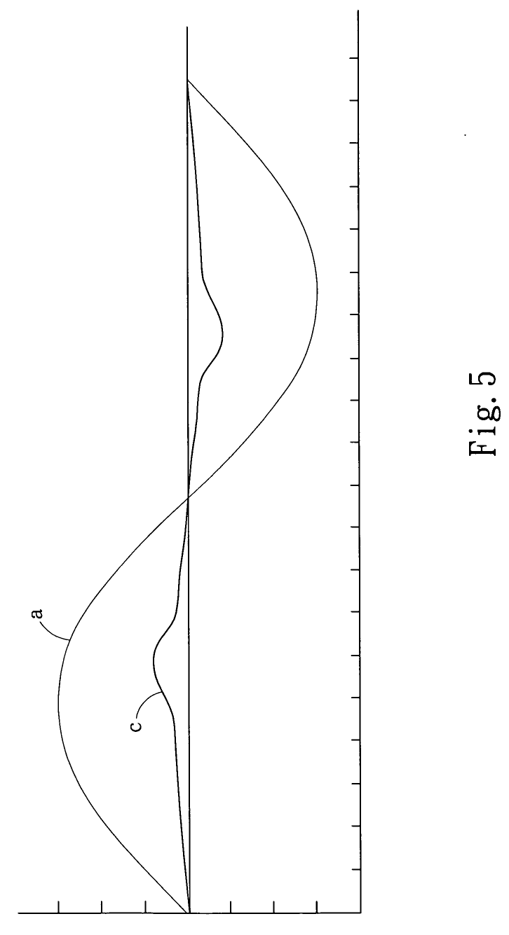

After the front voltage-booster loop 162 sends out the rated voltage a and the rated current b″ with the waveforms shown in FIG. 4 via the diode D1, the current will then be sent to the second filter circuit 17 via a diode D2 to charge the filter capacitors C5, C6 of the second filter circuit 17 in full phase; thereby, the current phase, which the first power factor regulating circuit 14 cannot amend, is offset, and the waveform of the offset current c is shown in FIG. 5.

The working power source output by the second filter circuit 17 is sent into the voltage transformer 19 via the power source push circuit 18 to be converted into the working power sources of different voltages therein; the working power sources of different voltages are separately processed by the output rectifier 20, which is coupled to the secondary side of the voltage transformer 19, and then respectively filtered by their own output filter circuits 23, 24 and then sent out. The working power source is also bypassed to the power source feedback circuit 21 so that according to the values calculated from the feedback signals, the controller IC 211 of the power source feedback circuit 21 can modify the working bandwidth of the gates of the power transistors Q1, Q2 and control the power that the power transistors Q1, Q2 output to the voltage transformer 19. The controller IC 211 is powered by the VCC power source circuit 22, and the VCC power source circuit 22 is further powered by a 5V-output STB working power source.

In summary, the improved power filter circuit of the present invention combines the advantages of the passive power filter circuit and the active power filter circuit and to meet the requirements of the electrical standard and achieve the objectives of small size and low fabrication cost.

The present invention has been described above with those preferred embodiments; however, it is not intended to limit the scope of the present invention, and any equivalent modification and variation according to the spirit of the present invention is still to be included within the scope of the present invention, and the scope of the present invention is defined in the claims stated below.

What is claimed is:

1. An improved power filter circuit, coupled to a rectifier having AC input terminals and DC output terminals, wherein two filter capacitors are coupled to said DC output terminals of said rectifier, and a power source filter circuit, which extends the current switch-on time that the DC current from said DC output terminals charges said two filter capacitors, is installed to said AC input terminals or said DC output terminals of said rectifier, and characterized in:
said power source filter circuit further comprises: a first power factor regulating circuit, creating a harmonic oscillation effect corresponding to said filter capacitors to have a first extended current switch-on time; and a second power factor regulator, utilizing boosted voltage to force said filter capacitors to store electrical energy, and having a second extended current switch-on time to offset said first extended current switch-on time.

2. The improved power filter circuit according to claim 1, wherein said first power factor regulating circuit is an inductor winding.

3. The improved power filter circuit according to claim 1, wherein said second power factor regulator further comprises:
a front voltage-booster loop, further comprising: a power transistor, a voltage-booster inductor winding, and at least one diode, and used to raise the voltage output by said rectifier to the rated value at which electrical energy can be stored in said two filter capacitors; and
a PWM controller, used to regulate the output of said front voltage-booster loop.

4. The improved power filter circuit according to claim 3, wherein said second power factor regulator further comprises a current-limiting protection loop, which acquires the power (number of watt) output by said front voltage-booster loop from a resistor R1 of said front voltage-booster loop and sends the value of said power output by said front voltage-booster loop to said PWM controller.

5. The improved power filter circuit according to claim 3, wherein said second power factor regulator further comprises an overvoltage protection loop, which is used to detect the voltage output by said front voltage-booster loop and sends the value of the voltage output by said front voltage-booster loop to said PWM controller.

6. The improved power filter circuit according to claim 3, wherein said second power factor regulator further comprises an error-amplifying loop, which is used to detect the terminal voltages of said two filter capacitors and sends the value of said terminal voltages of said two filter capacitors to said PWM controller.

7. The improved power filter circuit according to claim 3, wherein said second power factor regulator further comprises a line current-detecting loop; when the line terminal voltage reaches the terminal voltage of said two filter capacitors, said line current-detecting loop detects the massive current, which charges said two filter capacitors, from a resistor R2 and sends the value of said massive current, which charges said two filter capacitors, to said PWM controller.
